(19) United States
(12) Patent Application Publication
(10) Pub. No.: US 2023/0252285 A1
(43) Pub. Date: Aug. 10, 2023

(54) SPATIO-TEMPORAL GRAPH NEURAL NETWORK FOR TIME SERIES PREDICTION

(71) Applicant: Microsoft Technology Licensing, LLC, Redmond, WA (US)

(72) Inventors: Swati SHARMA, Hayward, CA (US); Srinivasan IYENGAR, Bangalore (IN); Kshitij KAPOOR, Uttar Pradesh (IN); Shun ZHENG, Beijing (CN); Wei CAO, Beijing (CN); Jiang BIAN, Beijing (CN); Shivkumar KALYANARAMAN, Bangalore (IN); John Patrick LEMMON, Kennewick, WA (US)

(73) Assignee: Microsoft Technology Licensing, LLC, Redmond, WA (US)

(21) Appl. No.: 18/046,013

(22) Filed: Oct. 12, 2022

Related U.S. Application Data
(63) Continuation of application No. PCT/CN2022/075671, filed on Feb. 9, 2022.

(51) Int. Cl. G06N 3/08

(52) U.S. Cl. CPC G06N 3/08

(57) ABSTRACT

A computing system is provided comprising a processor and a memory storing instructions executable by the processor. The instructions are executable to, during a run-time phase, receive run-time input data that includes time series data indicating a state of a graph network at each of a series of time steps. The graph network includes a plurality of nodes, and at least one edge connecting pairs of the nodes. The run-time input data is input into a trained graph neural network to thereby cause the graph neural network to output a predicted state of the graph network at one or more future time steps.

### CROSS-REFERENCE TO RELATED APPLICATION

This application is a continuation from International Application No. PCT/CN2022/075671 entitled SPATIO-TEMPORAL GRAPH NEURAL NETWORK FOR TIME SERIES PREDICTION filed Feb. 9, 2022, the entire contents of which are hereby incorporated by reference in its entirety for all purposes.

### BACKGROUND

Many systems include multiple entities that interact with one another. These systems are modeled as networks in which each entity is represented by a node and its interactions with another entity are represented by an edge. Such interactions result in network effects that impact features of the nodes. For example, in energy systems, an energy price and supply/demand at one node is affected by the energy price and the supply/demand for energy at other nodes. In addition, the energy price and supply/demand are affected by energy transmission rates between the nodes. Therefore, a technical challenge exists to forecast successive features of the nodes, as well as successive features of connections between the nodes.

### SUMMARY

A computing device is provided comprising a processor and a memory storing instructions executable by the processor. The instructions are executable to, during a run-time phase, receive run-time input data that includes time series data indicating a state of a graph network at each of a series of time steps. The graph network includes a plurality of nodes, and at least one edge connecting pairs of the nodes. The run-time input data is input into a trained graph neural network to thereby cause the graph neural network to output a predicted state of the graph network at one or more future time steps. The graph neural network includes a node spatial layer configured to receive, as input, the state of the graph network, and to output, for each node, an aggregate representation of a node neighborhood of the node. The graph neural network also includes an edge spatial layer configured to receive, as input for each edge of the at least one edge, a representation of embedded edge features, from the node spatial layer, an aggregate representation of a first node neighborhood of a first node connected by the edge, and from the node spatial layer, an aggregate representation of a second node neighborhood of a second node connected by the edge. The edge spatial layer is configured to output an aggregate representation of an edge neighborhood of the edge. A fully connected layer is configured to receive output data from the node spatial layer and the edge spatial layer via a temporal gate, and to combine the output data from the node spatial layer and the edge spatial layer with an input temporal state of the network to predict the state of the graph network at the one or more future time steps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of a system for predicting a state of a graph network.

FIG. 2 shows an example of a run-time implementation of the system of FIG. 1.

FIG. 3 shows an example of a graph network, including an example of a node neighborhood and an example of an edge neighborhood, which can be used in the system of FIG. 1.

FIG. 4 shows an example of a graph neural network (GNN) that can be used in the system of FIG. 1.

FIG. 5 shows an example of a spatial layer that can be used in the GNN of FIG. 4.

FIG. 6 shows a schematic diagram of an example decision management layer that can be used with the system of FIG. 1.

FIG. 7 is a plot of mean absolute prediction error (MAPE) for baseline time series and GNN-based predictive algorithms applied to an energy network.

FIGS. 8A-8B show a flowchart of an example method for predicting a state of a graph network according to one example embodiment.

FIG. 9 shows a block diagram of an example computing system.

### DETAILED DESCRIPTION

Integrating renewable energy sources into electric grids is a pivotal step in achieving net-zero carbon emissions. However, this is challenging due to the intermittent and non-dispatchable nature of renewables. Although energy storage allows for smoothing out the variability of renewable sources, taking appropriate action through geographically spread storage (charging or discharging) is non-trivial in a highly inter-connected electric grid. Specifically, any such action might impact the price stability in electric power exchanges and discourage higher renewable generation.

In the United States, European Union, and many other parts of the world, one way of matching the supply from generators and demand from consumers in electric grids is through energy trading. This allows for competitive bidding and prices that help to profitably operate power reserves.

Energy prices in such energy trading schemes are inherently complex with significant inter- and intra-country electric flows. Such network effects are hard to capture. The prices are dependent on various factors such as local supply and demand. Moreover, and invoking chaos theory, participating in such markets will inherently change the market.

Renewables hold significant promise in reducing carbon emissions. More recently, due to tremendous reduction in manufacturing cost with economies of scale, solar and wind energy sources provide power at very competitive prices without subsidies. As renewables still account for a small fraction of energy demand, an increase in their proliferation may help to mitigate carbon emissions.

However, integrating renewables is not straightforward as some of these sources produce power intermittently due to their dependence on prevalent weather conditions. Also, some of these sources are non-dispatchable and cannot be used to meet variable electricity demand. This inflexibility has led to curtailment in the power generation from such sources to maintain grid stability in several countries, disincentivizing fresh investments in new renewable energy.

As introduced above, due to network effects, supply and demand for energy in one place affects supply and demand in one or more other places. Forecasting these variables can foster higher integration of renewables and enable market players to place more profitable bids.

Graphs provide a way of encoding entities and the relationships between them. Recently there have been advances to incorporate graph neural networks (GNNs) using deep learning approaches to learn complex mapping functions to make decisions at node, edge or the graph level. More particularly, spatiotemporal forecasting approaches attempt to predict future node and edge features using the spatial structure and historical feature values. One of the ways this is achieved is by stacking or combining a spatial module, such as a graph convolutional network (GCN), with a temporal module, such as Long Short-Term Memory (LSTM) or Gated Recurrent Units (GRUs).

A temporal graph neural network (TGNN) trained on a plurality of temporal states of a network can predict successive features of the nodes. However, these predictions are subject to error in some instances where TGNNs do not account for changes in multidimensional edge feature vectors. Therefore, a technical challenge exists to predict multidimensional edge and node attributes, which are both time series, based upon preceding temporal states of the network.

To address these issues, examples are disclosed that relate to using a graph neural network to predict a state of a graph network at one or more future time steps based upon run-time input data that includes time series data indicating a state of the graph network at each of a series of time steps. Briefly, the graph neural network includes a node spatial layer configured to receive, as input, the state of the graph network, and to output, for each node, an aggregate representation of a node neighborhood of the node. The graph neural network also includes an edge spatial layer. The edge spatial layer is configured to receive, as input for each edge of the at least one edge, a representation of embedded edge features. The input also includes, from the node spatial layer, an aggregate representation of a first node neighborhood of a first node connected by the edge, and an aggregate representation of a second node neighborhood of a second node connected by the edge. The edge spatial layer is configured to output an aggregate representation of an edge neighborhood of the edge. A fully connected layer is configured to receive output data from the node spatial layer and the edge spatial layer via a temporal gate, and to combine the output data from the node spatial layer and the edge spatial layer with an input temporal state of the network to predict the state of the graph network at the one or more future time steps. In this manner, the graph neural network enables forecasting or estimation at both node and edge levels for time series data.

A GNN-based approach is also used to model energy markets. This model enables counterfactual analysis to help energy generators and consumers answer questions such as how changes in production at one node change volumes and prices at other nodes. As introduced above, the dynamic nature of the nodes as well as the edges poses a technical challenge in modeling this multi-objective problem. The model was evaluated on a large, real-world, multi-year energy exchange dataset. Advantageously, accounting for the interconnected nature of electric grids can significantly increase accuracy of price prediction over variable volumes compared to traditional time series prediction approaches. It will also be appreciated that the models disclosed herein have applicability in a wide range of domains, such as state estimation problems in power system stability and supply chain management.

An energy market is modeled with multiple market participants (energy buyers and suppliers) with interconnections between them using a graph structure. The nodes of the graph are market participants and edges are the physical interconnections between them. GNNs are used as they allow the application of neural networks directly to graphs, and perform node and edge level tasks. They are used to forecast prices, which is a nodal property, as well as to forecast energy flow, which is the energy exchanged between two participants, an edge property. One technical challenge here is the coupling between a temporally varying node as well as edge features (for example, the flow of electricity will be to a region that can pay a higher price and has enough demand). An additional technical challenge is the existence of constraints on the edge features (for example, the flow of electricity is less than or equal to the capacity of an edge). As described in more detail below, GNN modeling provides forecasts for the next 24 hours (day ahead market) that account for 90% of energy trading.

In summary, a constrained multi-objective (e.g., price and energy exchange) forecasting problem is solved by the systems disclosed herein, incorporating multidimensional edge and node time-series features. The approach is evaluated on the Nordpool energy dataset (available from Nord Pool AS of Oslo, Norway) and the proposed approach has been shown to outperform many prior time-series forecasting approaches.

The nature of energy markets is dynamic where the power generators and consumers have characteristics that vary temporally. In addition, the properties of the physical connections between these nodes, which are also temporally varying, influence the spatiotemporal evolution of each other. In this framework, the disclosed systems and methods make forecasts for each node and edge present in the graph. Without loss of generality, the price prediction problem is used in the energy domain to demonstrate the framework. It will also be appreciated that this framework is generic and can be applied to other domains as well, where the node and edge features are both time series signals. In this section, the architecture incorporating multi-dimensional node and edge features in a GNN is disclosed and predictions are made at the node and edge level.

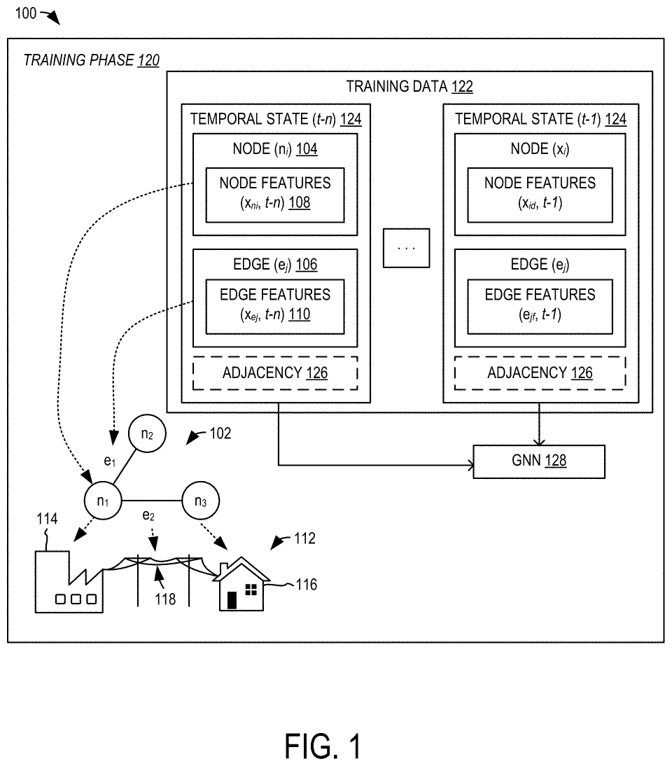

FIG. 1 depicts one example of a system 100 for predicting a state of a graph network 102. As described in more detail below, FIG. 1 also depicts one potential use-case example in which the graph network 102 comprises an energy network. The graph network 102 comprises a plurality of nodes (nᵢ) 104 and a plurality of edges (eⱼ) 106 connecting pairs of the nodes 104.

Each node (xᵢ) of the plurality of nodes comprises a plurality of node features (xₙᵢ) 108. In addition, each edge (eⱼ) comprises a plurality of edge features (xₑⱼ) 110. In some examples, each of the node features (xₙᵢ) 108 and each of the edge features (xₑⱼ) are variable between each state of the graph network 102 (e.g., the node features and the edge features can change between different time steps).

As introduced above, in some examples, the network representation 102 is used to model an energy distribution graph network 112. In the energy distribution graph network 112, the plurality of nodes 104 represent a plurality of energy generation subsystems 114 (e.g., solar farms, wind farms, power plants, or geographic regions that produce energy) and/or energy consumption subsystems 116 (e.g., homes, businesses, or geographic regions that consume energy). Each edge represents an energy distribution linkage between respective subsystems connected by that linkage.

In the energy distribution graph network 112, each state of the graph network includes, as node features for each node, an energy price and a rate of energy generation or energy consumption at that node. Each state of the graph network also includes, as edge features for each edge, an energy transmission rate and an energy transmission capacity. In some examples, as described in more detail below, the energy transmission rate is constrained by the energy transmission capacity.

Graph networks, such as the graph network 102 and the energy distribution graph network 112, can be represented as G(V, E), where V defines a set of Nᵥ=|V| nodes and E defines a set of Nₑ=|E| edges. The input features at the l-th layer of the GNN are Xₙ=xₙ₁, xₙ₂, . . . , x_{nN}_{ᵥ}, where Xₙ∈R^{N}^{ᵥ}^{×H×P}, where R is the set of real numbers, H represents the length of the time series and P is the length of the node embedding dimension. Similarly, Xₑ=xₑᵢⱼ, where nodes nᵢ and node nⱼ are adjacent. Xₑ∈R^{N}^{ₑ}^{×H×P}, where H represents the length of the time series and Q>=1 is the size of the edge embedding dimension.

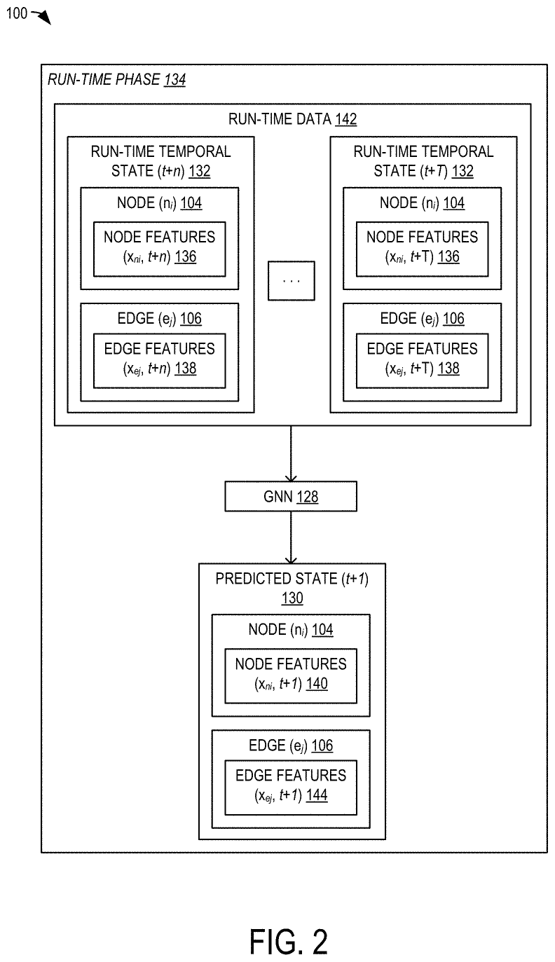

During a training phase 120, the system 100 is configured to receive training data 122. The training data includes time series data indicating a state 124 of the graph network at each of a series of time steps. In some examples, as depicted in FIG. 1, the time steps used in the training data are historical and describe the states of the network 102 at times (t−n) through (t−1). As described in more detail below with reference to FIGS. 1 and 2, the training data 122 is used to train a graph neural network 128 to output a predicted state 130 of the graph network 128 at a successive time step based on a run-time input state 132, thereby enabling the joint forecasting of node and edge features.

Each state 124 of the network includes, for each node (nᵢ) 104 of the plurality of nodes (Σnᵢ), a plurality of node features (xₙᵢ) 108 in that temporal state. For example, the node feature (xₙᵢ, t−n) corresponds to the node (nᵢ) at time (t−n). Likewise, each temporal state 124 includes, for each edge (eⱼ) 106, a plurality of edge features (xₑⱼ) 110 in that temporal state.

In some examples, each state of the graph network 102 further comprises adjacency information 126, such as an adjacency matrix or an adjacency list. The adjacency information 126 further defines a structure of the network 102 by indicating pairs of nodes 104 that are joined by an edge 106. In some examples, it is assumed that the structure of the graph is static. In other examples, adjacency matrix elements are no longer 0 or 1, but are dynamic and multidimensional.

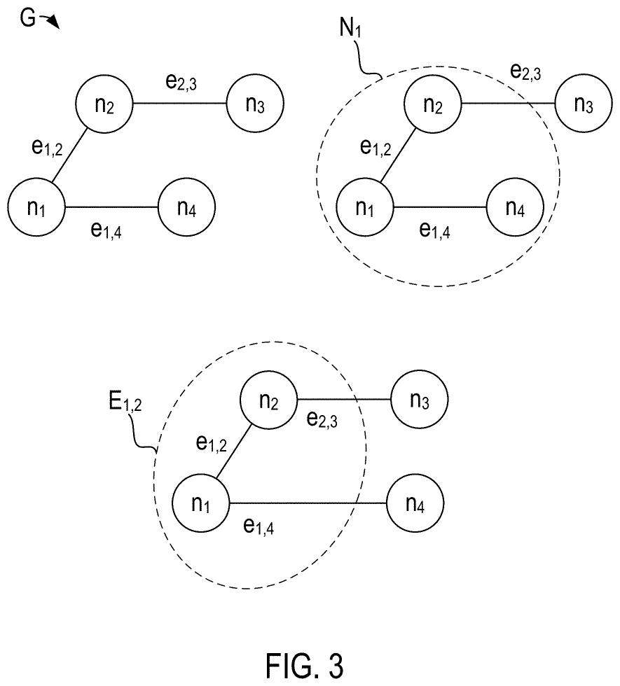

As described in more detail below, the graph neural network 128 aggregates features of the graph based on node neighborhoods and edge neighborhoods. FIG. 3 shows an example of a graph network G, and depicts an example of a node neighborhood Nᵢ and an example of an edge neighborhood Eᵢⱼ within the graph G. The graph network G includes a plurality of nodes n₁, n₂, n₃, and n₄. The graph network G also includes a plurality of edges e_{1,2}, e_{2,3}, and e_{1,4}. Edge e_{1,2} connects nodes n₁ and n₂, edge e_{2,3} connects nodes n₂ and n₃, and edge e_{1,4} connects nodes n₁ and n₄.

A node neighborhood Nᵢ of a node nᵢ includes other nodes n connected to the node nᵢ. FIG. 3 shows an example of a node network N₁ for the node n₁. The node network N₁ includes nodes n₁, n₂ (which is connected to n₁ via edge e_{1,2}) and n₄ (which is connected to n₁ via edge e_{1,4}).

An edge neighborhood, Eᵢⱼ of edge eᵢⱼ (connecting node nᵢ and node nⱼ) includes edges connected to nᵢ and nⱼ as well as the nodes nᵢ and nⱼ. FIG. 3 shows an example of an edge network E_{1,2} for the edge e_{1,2}. The edge network E_{1,2} includes the edge e_{1,2}, node n₁ and node n₂. The edge network E_{1,2} also includes the edge e_{1,4} (which is connected to the node n₁) and the edge e_{2,3} (which is connected to the node n₂).

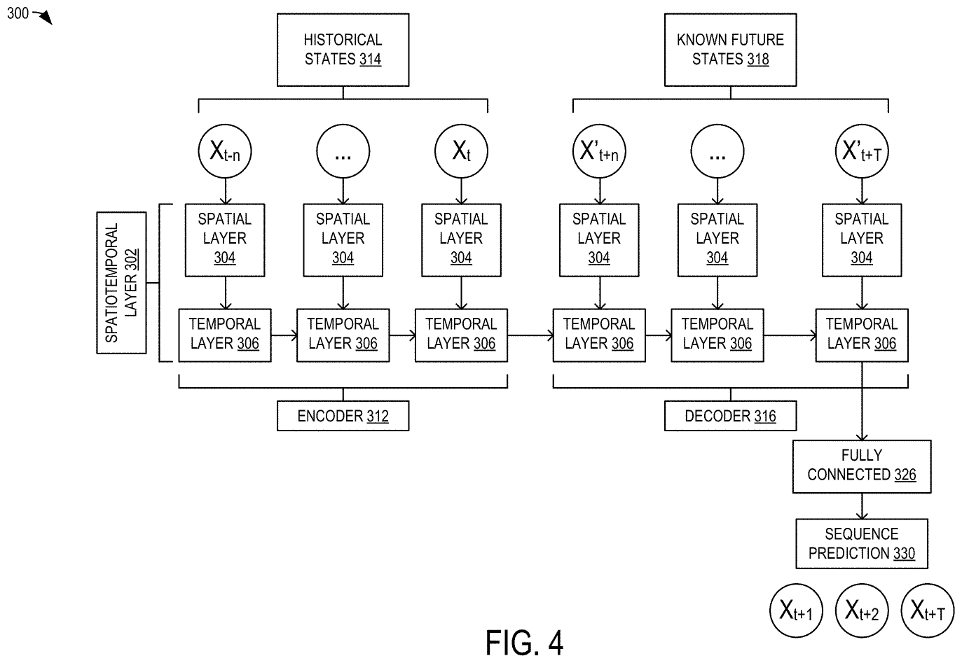

FIG. 4 shows an example of a graph neural network 300 that encodes spatial and temporal interactions for both nodes and edges. The graph neural network 300 can serve as the GNN 128 of FIG. 1. The GNN 300 includes a spatiotemporal layer 302 comprising a spatial layer 304 and a temporal layer 306. In this manner, the GNN 300 is configured to model spatiotemporal changes in a graph network. As depicted in FIG. 4, the spatial layer 304 includes a node spatial layer 308 and an edge spatial layer 310. The node spatial layer 308 and the edge spatial layer 310 encode spatial interactions for both nodes and edges.

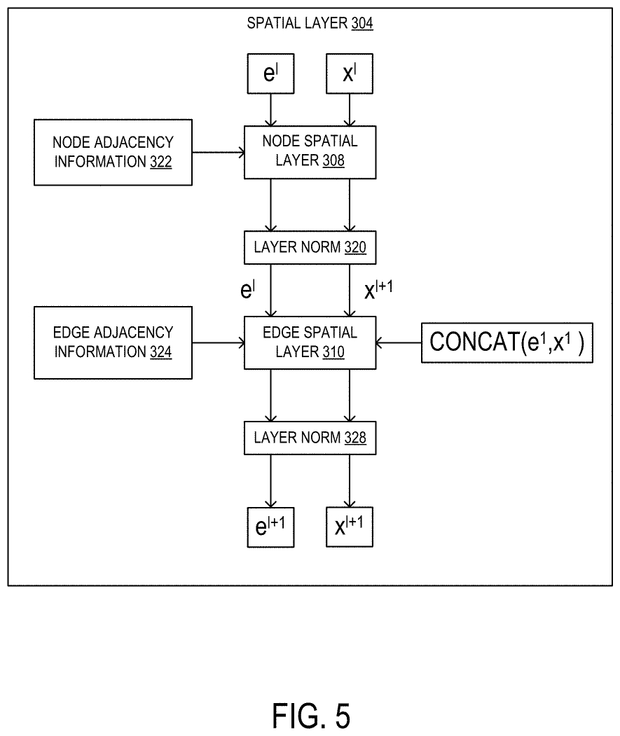

As illustrated in FIGS. 4 and 5, the node spatial layer 308 is configured to receive, as input the state X of the graph network at a time step t. For example, in an encoder portion 312 of the GNN model 300, the input is a historical state 314 of the graph network at a time step selected from Xₜ₋ₙ through Xₜ. In a decoder portion 316 of the GNN model 300, the input is a known future state 318 of the graph network at a time step selected from X′ₜ₊ₙ through X′_{t+T}.

The node spatial layer 308 allows the system to learn the spatial features for each node and the edge features act as a weight on those features. The node spatial layer is configured to output, for each node, an aggregate representation of a node neighborhood of the node.

In some examples, the node spatial layer 308 comprises a sigmoidal function as follows:

xᵢ^{l+1}=σ(Wₙ^{l}(xᵢ+AGG(xⱼ,eᵢⱼ)),xⱼ)∈Nᵢ, where eᵢⱼ∈E (1)

At the node-level layer, the neighbors of node xᵢ are aggregated based on its node neighborhood Nᵢ. Here, Wₙ^{l} is a nodewise weight at level l, xᵢ is a representation of a first node, AGG(xⱼ, eᵢⱼ) is an aggregate of a representation of a second node xᵢ connected to the first node, and eᵢⱼ is a representation of an edge connecting the first node and the second node. For simplicity, t is omitted from the equation.

The edge spatial layer 310 is configured to receive, as input for each edge of the at least one edge, a representation of embedded edge features. The input also includes, from the node spatial layer, an aggregate representation of a first node neighborhood of a first node connected by the edge and an aggregate representation of a second node neighborhood of a second node connected by the edge.

In some examples, the input to the edge spatial layer is a concatenated node embedding and edge embedding according to the edge neighborhood.

eᵢⱼ^{l}=CONCAT(eᵢⱼ^{l},xᵢ^{l+1},xⱼ^{l+1}), where eᵢⱼ∈E, and where xᵢ,xₖ∈N (3)

The outputs of the node spatial layer 308 (e.g., xᵢ^{l+1} and xⱼ^{l+1}) optionally pass through a normalization layer 320 before being provided to the edge spatial layer 310. Accordingly, and in one potential advantage of the present disclosure, the normalization layer 320 standardizes the outputs of the node spatial layer 308 (e.g., by providing a suitable mean and variance) for input to the edge spatial layer 310, enabling more accurate prediction by the GNN 300.

In some examples, the node spatial layer 308 utilizes node adjacency information (e.g., based on one or more node neighborhoods). On the other hand, the edge spatial layer 310 uses different edge adjacency information 324, (e.g., where spatial features are aggregated from the edge features as well as node features based on the edge neighborhood). Using the node features in the edge spatial layer allows the system to utilize a richer feature set when estimating for the edges.

The edge spatial layer 310 outputs an aggregate representation of an edge neighborhood of the edge. In some examples, the edge spatial layer comprises a sigmoidal function as follows:

eᵢⱼ^{l+1}=σ(Wₑ^{l}(eᵢⱼ+AGG(eₖₗ)),eₖₗ)∈Nᵢ, where eₖₗ∈E (2)

Here, Wₑ^{l} is an edgewise weight at level l, eᵢⱼ is a representation of a first edge connecting a first node (i) and a second node (j), and AGG(eₖₗ) is an aggregate of a representation of a second edge connecting a third node (k) and a fourth node (l).

For simplicity, t is omitted from the equation.

The GNN 300 further comprises a fully connected layer 326. The fully connected layer 326 is configured to combine the output data from the node spatial layer and the edge spatial layer with an input temporal state of the network to predict the state of the graph network at the one or more future time steps. For example, the fully connected layer 326 is configured to output a sequence prediction 330 including predicted states Xt+1, Xt+2, . . . , Xt+T at one or more future time steps.

The fully connected layer 326 is configured to receive output data from the node spatial layer 308 and the edge spatial layer 310 via a temporal gate. In some examples, the temporal gate is implemented at the temporal layer 306. It will be appreciated that the temporal gate comprises any suitable temporal feedback system. In some examples, the temporal gate comprises a gated recurrent unit (GRU) or a long short-term memory (LSTM). Advantageously, the temporal gate is configured to regulate information flow between time steps in the GNN 300, thereby stabilizing the GNN 300 by preventing vanishing and/or exploding gradients during training.

The outputs of the node spatial layer 308 and/or the edge spatial layer 310 (e.g., eᵢⱼ^{l+1}, xᵢ^{l+1} and xⱼ^{l+1}) optionally pass through a normalization layer 328 before being provided to the temporal layer 306 and/or the fully connected layer 326. Advantageously, like the normalization layer 320, the normalization layer 328 standardizes the outputs of the node spatial layer 308 and/or the edge spatial layer 310, enabling more accurate prediction by the GNN 300.

During training, the goal is to minimize the error between a true value, Yₜ and a predicted value, Yₜ^{pred}. In some examples, Y represents the price of energy at each node and energy exchange on each edge.

At each edge, the capacity of the transmission line, cₜ imposes an upper limit on the energy exchange, fₜ. In some examples, a penalty method is used to satisfy the inequality constraint fₜ−cₜ=0. L_{reg} is a regularization term and λ_{reg} are Lagrange multipliers.

L=∥Yₜ^{pred}−Yₜ∥+λmax(0,fₜ−cₜ)+λ_{reg}L_{reg} (4)

With reference again to FIG. 2, during a run-time phase 134, the system 100 is configured to receive run-time input data 142. The run-time input data 142 includes time series data indicating a run-time state 132 of the graph network 102 at each of a series of time steps. The run-time state 132 includes, for each node (nᵢ), a plurality of run-time node features (xₙᵢ, t) 136. The run-time state 132 also includes, for each edge (eⱼ) 106 of the at least one edge, a plurality of run-time edge features (xₑⱼ, t) 138. In this manner, the run-time input data 142 corresponds to the training data 122 of FIG. 1.

The run-time input data 142 is input into the trained GNN 128 to thereby cause the GNN 128 to output a predicted state 130 of the graph network at one or more future time steps (e.g., t+1). The predicted state 130 includes, for each node (m), a plurality of predicted node features 140, e.g. (xₙᵢ, t+1). The predicted state 130 also includes, for each edge (eⱼ) 106, a plurality of predicted edge features 144, e.g. (xₑⱼ, t+1). In this manner, the system 100 can accurately forecast features of both the nodes and the edges at a successive time step.

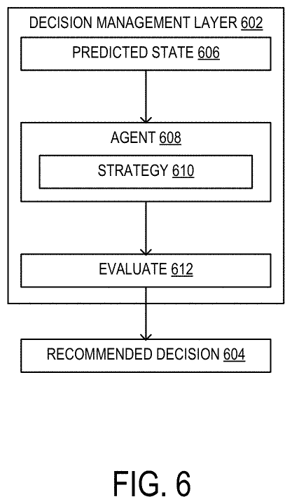

In some examples, and with reference now to FIG. 6, in some examples, a decision management layer 602 is used to output a recommended action 604 based upon a predicted state 606 of a graph network, such as the predicted state 330 of FIG. 4 or the predicted state 130 of FIG. 2. The predicted state 606 is input into a decision-making agent 608 configured to implement a strategy 610 to recommend an action in response to the predicted state 606. Some examples of suitable strategies 610 include, but are not limited to, renewable energy generation strategies (e.g., determining when to sell energy to an electrical grid and/or how much energy to sell to the grid) and energy storage operation strategies (e.g., when to charge a battery and when to discharge a battery). The strategy 610 is evaluated at 612, and used to generate the recommended action 604. In this manner, the decision management layer 602 is configured to output a recommended action to achieve a desired objective (e.g., emission reduction).

As introduced above, the open-source Nordpool dataset was used to evaluate the GNN-based approach to modeling energy systems. Nordpool runs a leading power market in Europe, including both day-ahead and intraday markets. The model was evaluated on the day-ahead market, where the bulk of the energy trading takes place. It was assumed that the historical total production, total consumption (including quantities traded in the intraday market), prices, and flow among nodes are known. A second assumption was that future values for the load and supply for all nodes and the transmission capacities between the nodes were available. The hourly day-ahead data was used between the years 2013-2019.

At the time of this evaluation, there were 15 zones from four countries (Denmark, Finland, Lithuania, Latvia, Norway and Sweden). Note that in this graph-based formulation, each node represented a zone or country that participated in the Nordpool market, and edges represented the transmission capabilities between different nodes (zone-to-zone or zone-to-country). In addition, flow and transmission capacities were represented as edge features whereas prices, load, supply, production and consumption were node features. Feature scaling was applied to each node and edge feature for scale-sensitive methods was considered (e.g., LSTNET and TGCN).

In simulated experiments, a lookback window of 7 days was used. This means 7×24 historical data samples were available. The prediction window was the next 24 hours.

Baselines were established using time series approaches and GNN approaches. The time series approaches evaluated included NBeats, N-Beatsx (a multivariate implementation of N-Beats), LSTNet, and LSTNetx (a multivariate implementation of LSTNET). The GNN approaches included TGCN, TGCN-attention, and the flow prediction approach described above.

The following two metrics were used to evaluate this approach:

Mean Absolute Prediction Error

$$nMAE = \frac{{\sum }_{n = 0}^{N} {\sum }_{t = 0}^{M} \vert {y}_{t}^{n} - {\hat{y}}_{t}^{n} \vert}{{\sum }_{n = 0}^{N} {\sum }_{t = 0}^{M} {y}_{t}^{n}} \qquad ( 5 )$$

Normalized Root Mean Squared Error

$$nRMSE = \frac{\sqrt{\frac{1}{MN} {\sum }_{n = 0}^{N} {\sum }_{t = 0}^{M} {( {y}_{t}^{n} - {\hat{y}}_{t}^{n} )}^{2}}}{\frac{1}{MN} {\sum }_{n = 0}^{N} {\sum }_{t = 0}^{M} {y}_{t}^{n}} \qquad ( 6 )$$

Here, yₜⁿ and ŷₜⁿ are the price and energy exchange for time sample t and for the nodes and edges n. M is the number of time samples and n is the number of nodes and edges.

The batch size was 128. As introduced above, the lookback period was 7*24 hours. The look ahead window was 24 hours. Data from the years 2014-2016 was used for training, data from 2017 was used for validation, and data from 2018 was used for training. Wind prediction was used in predicting demand, which was performed at a local level (e.g., at individual wind farms) as global-scale prediction is noisy.

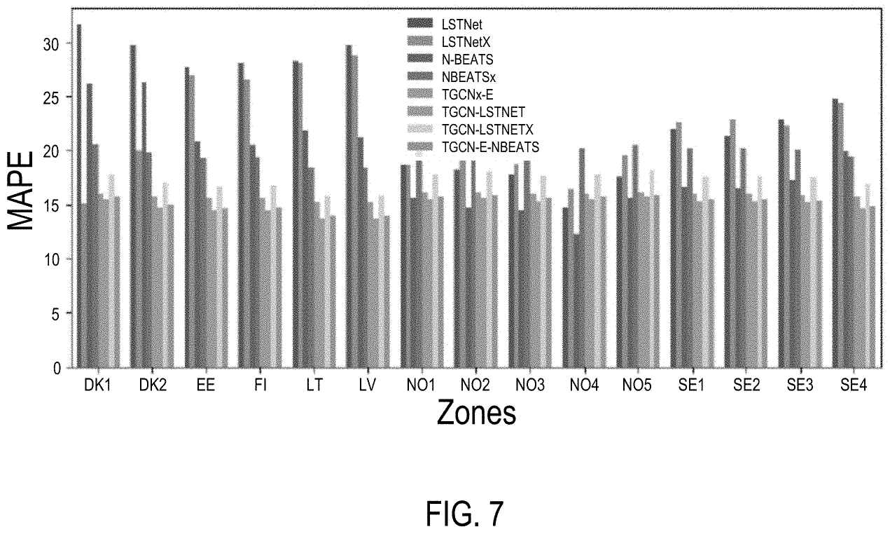

Table 1 shows a comparison of the baseline results. FIG. 7 shows a plot of the mean absolute prediction error (MAPE) using each approach.

TABLE 1

| Model | nMAE | nRMSE |
|---|---|---|
| LSTNet | 0.237 | 0.353 |
| LSTNetx | 0.3522 | 0.5528 |
| NBEATS | 0.1877 | 0.2747 |
| GNN | 0.159 | 0.252 |
| GNNx | 0.1543 | 0.2494 |
| NBEATS-GNN | 0.162 | 0.256 |
| LSTNET-GNN | 0.165 | 0.256 |
| NBEATSx-GNN | 0.159 | 0.252 |
| LSTNETx-GNN | 0.161 | 0.254 |
| NBEATS-GNNx | 0.150 | 0.247 |
| NBEATSx-GNNx | 0.152 | 0.248 |

Node-wise error was computed using LSTNET, LSTNETx, NBEATS, NBEATSx, GNN-E (price only), GNNx-E (exogenous), GNN-E (price only)+LSTNET GNN-E (price only)+LSTNETx GNN-E (exo)+LSTNET GNN-E (exo)+LSTNETx GNN-E (price only)+NBEATS GNN-E (price only)+NBEATSx GNN-E (exo)+NBEATS GNN-E (exo)+NBEATSx using wind and not using wind in the loss function. It is shown that the present approach described herein provides more accurate results than the baselines (NBEATS, NBEATSx, GNN, GNN-X), showing that GNN-X provides more reliable predictions than GNN.

Temporal module modification was also performed on GNN-X, GNN-X with NBEATS, NBEATSx, LSTNET, and LSTNETx. Joint flow and price estimation show the impact of incorporating flow in these models. Flow prediction can be used to plan for capacity shortfalls.

Simple, time-based policies were implemented in the decision management layer. For example, a battery simulated to be charged at night when prices were low, or discharged when prices were high, which was grid related. In some examples, policies are implemented at the decision management layer to maximize profit. In other examples, policies are implemented at the decision management layer to minimize emissions. For example, when prices are high, more dirty fuel may be used to produce energy and meet demand. However, the decision management layer can output recommended actions to reduce emissions.

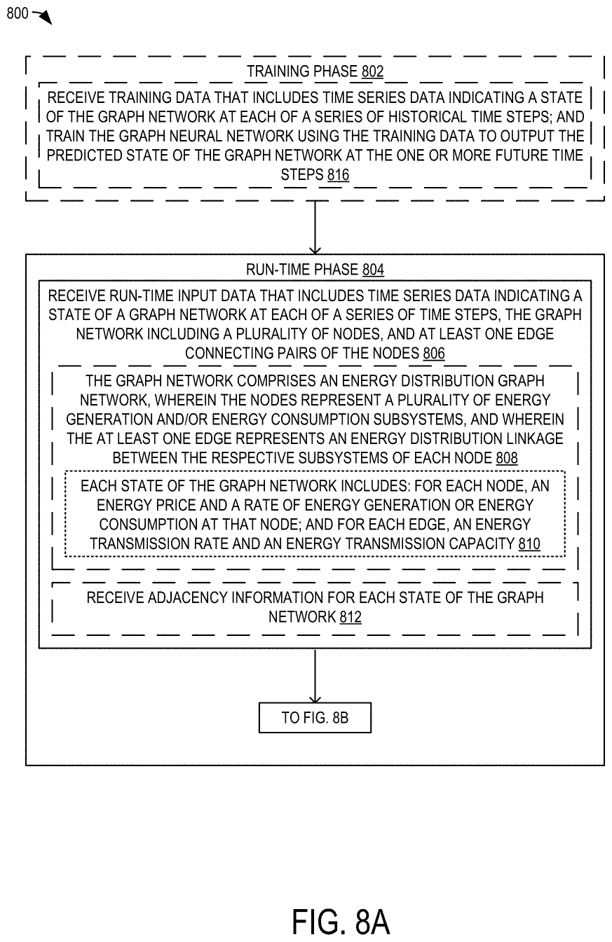

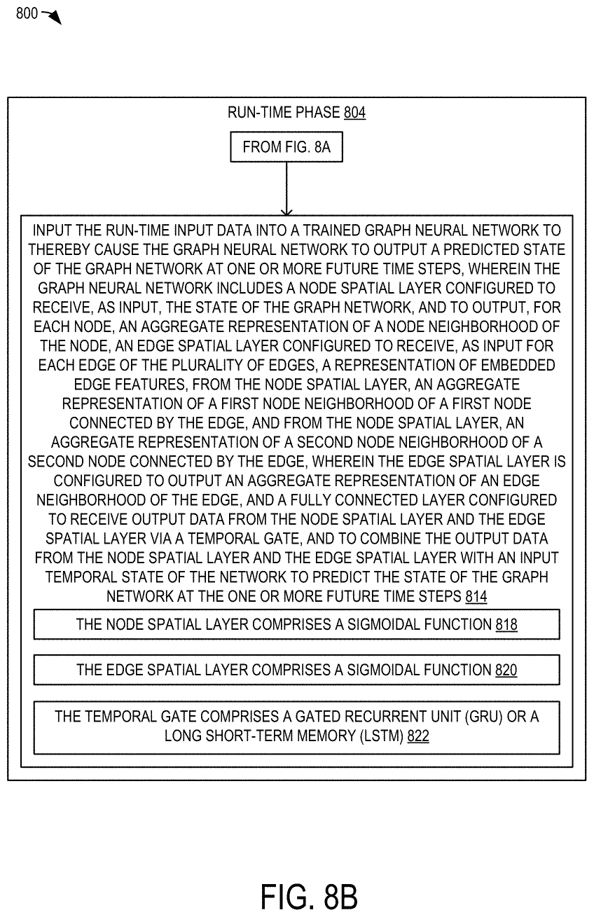

With reference now to FIGS. 8A-8B, a flowchart is illustrated depicting an example method 800 for predicting a state of a graph network. The following description of method 800 is provided with reference to the software and hardware components described above and shown in FIGS. 1-7 and 9, and the method steps in method 800 will be described with reference to corresponding portions of FIGS. 1-7 and 9 below. It will be appreciated that method 800 also may be performed in other contexts using other suitable hardware and software components.

It will be appreciated that the following description of method 800 is provided by way of example and is not meant to be limiting. It will be understood that various steps of method 800 can be omitted or performed in a different order than described, and that the method 800 can include additional and/or alternative steps relative to those illustrated in FIGS. 8A and 8B without departing from the scope of this disclosure.

In some examples, the method 800 includes steps performed at a training phase 802 and steps performed at a run-time phase 804. In some examples, the training phase 802 serves as the training phase 120 of FIG. 1, and the run-time phase 804 serves as the run-time phase 134.

With reference now to FIG. 8A, at 806, the method 800 includes, during the run-time phase 804, receiving run-time input data that includes time series data indicating a state of a graph network at each of a series of time steps, the graph network including a plurality of nodes, and at least one edge connecting pairs of the nodes. For example, the run-time input data 142 of FIG. 2 includes time series data indicating a state 132 of the graph network 102 of FIG. 1 at each of a series of time steps. In this manner, the run-time input data represents the spatiotemporal state of the graph network at runtime.

In some examples, as indicated at 808, the graph network comprises an energy distribution graph network, wherein the nodes represent a plurality of energy generation and/or energy consumption subsystems, and wherein the at least one edge represents an energy distribution linkage between the respective subsystems of each node. For example, the graph network 102 of FIG. 1 may represent an energy distribution network 112. In this manner, the system 100 of FIG. 1 is configured to model the spatiotemporal evolution of the energy distribution network 112.

At 810, in some examples, each state of the graph network includes: for each node, an energy price and a rate of energy generation or energy consumption at that node; and for each edge, an energy transmission rate and an energy transmission capacity. For example, the graph network 102 of FIG. 1 may be used to model the energy price and a rate of energy generation or energy consumption at subsystems 114 and 116, and an energy transmission rate and an energy transmission capacity at transmission lines 118. In this manner, the system 100 of FIG. 1 is configured to model price and energy flow in the energy distribution network 112.

In some examples, the models disclosed herein can be trained to predict congestion between nodes. For example, the utilization of power transmission lines can vary over time due to the intermittent generation of renewable electricity, which can lead to one or more transmission lines reaching capacity. Accordingly, a GNN (e.g., the GNN 128 of FIG. 1) can be trained to predict a network state in which one or more transmission lines (modeled as a network edges) are at capacity. Based upon the attributes of other edges in the model (representing other transmission lines in a power grid), a decision management layer (e.g., the decision management layer 602 of FIG. 6) outputs a recommended course of action to route electricity through the power grid when the one or more transmission lines are at capacity. Other grid operations may also be controlled in a similar manner.

As introduced above, the models disclosed herein are also applicable in a wide range of domains beyond modeling energy systems. For example, the GNN 128 can be trained to forecast demand in domains such as supply chain management and logistics. Demand forecasting using GNNs poses a technical challenge, as described above, due to network effects. These challenges can be addressed by utilizing the architecture described above with reference to FIGS. 4 and 5. This approach incorporates network effects by modeling both node and edge attributes to provide accurate predictions of time-series features in a graph network, such as a graph representation of a supply chain.

In some examples, at 812, receiving the run-time input data further comprises receiving adjacency information for each state of the graph network. For example, the training data 122 optionally includes adjacency information 126. The node spatial layer 308 of FIG. 5 is configured to receive node adjacency information 322 and the edge spatial layer 310 of FIG. 5 is configured to receive edge adjacency information 324. Accordingly, and in one potential advantage of the present disclosure, the adjacency information provides the GNN 128 with further definition of at least a portion of the graph network's structure.

With reference now to FIG. 8B, at 814, the method 800 includes inputting the run-time input data into a trained graph neural network to thereby cause the graph neural network to output a predicted state of the graph network at one or more future time steps, wherein the graph neural network includes, a node spatial layer configured to receive, as input, the state of the graph network, and to output, for each node, an aggregate representation of a node neighborhood of the node, an edge spatial layer configured to receive, as input for each edge of the at least one edge, a representation of embedded edge features, from the node spatial layer, an aggregate representation of a first node neighborhood of a first node connected by the edge, and from the node spatial layer, an aggregate representation of a second node neighborhood of a second node connected by the edge, and wherein the edge spatial layer is configured to output an aggregate representation of an edge neighborhood of the edge, and a fully connected layer configured to receive output data from the node spatial layer and the edge spatial layer via a temporal gate, and to combine the output data from the node spatial layer and the edge spatial layer with an input temporal state of the network to predict the state of the graph network at the one or more future time steps. For example, the run-time input data 142 of FIG. 2 is input into the GNN 128, which outputs the predicted state 130 in response. In this manner, the GNN is configured to enable prediction of a successive state of the graph network. Furthermore, the structure of the GNN enables joint forecasting or estimation at both node and edge levels for time series data.

With reference again to FIG. 8A, in some examples, the method 800 includes, during the training phase 802, receiving training data that includes time series data indicating a state of the graph network at each of a series of historical time steps, and training the graph neural network using the training data to output the predicted state of the graph network at the one or more future time steps, as indicated at 816. For example, the GNN 128 is trained on the training data 122 of FIG. 1. The training data corresponds to the run-time input data, thereby enabling the GNN to predict a successive temporospatial state of the graph network.

With reference again to FIG. 8B, in some examples, as indicated at 818, the node spatial layer comprises a sigmoidal function σ(Wₙ^{l}(xᵢ+AGG(xⱼ, eᵢⱼ)),xⱼ), where Wₙ^{l} is a nodewise weight at level l, AGG(xⱼ, eᵢⱼ) is an aggregate of a representation of a node xⱼ connected to a node xⱼ, and eᵢⱼ is a representation of an edge connecting the node xᵢ and the node xⱼ. In this manner, the node spatial layer enables the spatial features for each node to be learned, with the edge features acting as a weight on the node features.

In some examples, as indicated at 820, the edge spatial layer comprises a sigmoidal function σ(Wₑ^{l}(eᵢⱼ+AGG(eₖₗ)), eₖₗ), where Wₑ^{l} is an edgewise weight at level l, eᵢⱼ is a representation of a first edge connecting a node (i) and a node (j), and AGG(eₖₗ) is an aggregate of a representation of a second edge connecting a node (k) and a node (l). In this manner, the edge spatial layer incorporates node features, which enables the GNN to use a richer feature set to accurately predict edge features.

At 822, in some examples, the temporal gate comprises a gated recurrent unit (GRU) or a long short-term memory (LSTM). In some examples, the temporal layer 306 comprises a GRU or an LSTM. In this manner, the temporal gate is configured to prevent vanishing and/or exploding gradients during training.

In some embodiments, the methods and processes described herein may be tied to a computing system of one or more computing devices. In particular, such methods and processes may be implemented as a computer-application program or service, an application-programming interface (API), a library, and/or other computer-program product.

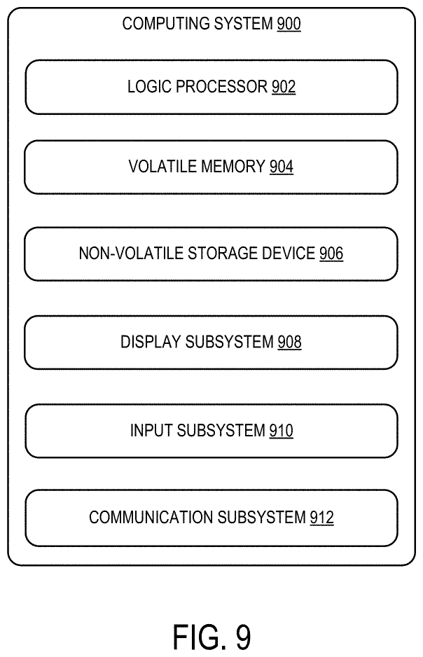

FIG. 9 schematically shows an example of a computing system 900 that can enact one or more of the devices and methods described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

The computing system 900 includes a logic processor 902 volatile memory 904, and a non-volatile storage device 906. The computing system 900 may optionally include a di splay subsystem 908, input sub system 910, communication subsystem 912, and/or other components not shown in FIG. 9.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 may include physical devices that are removable and/or built in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module”, “program” and “engine” may be used to describe an aspect of computing system 900 typically implemented in software by a processor to perform a particular function using portions of volatile memory, which function involves transformative processing that specially configures the processor to perform the function. Thus, a module, program or engine may be instantiated via logic processor 902 executing instructions held by non-volatile storage device 906, using portions of volatile memory 904. It will be understood that different modules, programs and/or engines may be instantiated from the same application, service, code block, object, library, routine, API, function, etc. Likewise, the same module, program and/or engine may be instantiated by different applications, services, code blocks, objects, routines, APIs, functions, etc. The terms “module”, “program” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some examples, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. For example, the communication subsystem may be configured for communication via a wireless telephone network, or a wired or wireless local- or wide-area network. In some examples, the communication subsystem may allow computing system 900 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a processor; and
a memory storing instructions executable by the processor to,
during a run-time phase,
receive run-time input data that includes time series data indicating a state of a graph network at each of a series of time steps, the graph network including a plurality of nodes, and at least one edge connecting pairs of the nodes, and
input the run-time input data into a trained graph neural network to thereby cause the graph neural network to output a predicted state of the graph network at one or more future time steps, wherein the graph neural network includes,
a node spatial layer configured to receive, as input, the state of the graph network, and to output, for each node, an aggregate representation of a node neighborhood of the node,
an edge spatial layer configured to receive, as input for each edge of the at least one edge,
a representation of embedded edge features,
from the node spatial layer, an aggregate representation of a first node neighborhood of a first node connected by the edge, and
from the node spatial layer, an aggregate representation of a second node neighborhood of a second node connected by the edge, and
wherein the edge spatial layer is configured to output an aggregate representation of an edge neighborhood of the edge, and
a fully connected layer configured to receive output data from the node spatial layer and the edge spatial layer via a temporal gate, and to combine the output data from the node spatial layer and the edge spatial layer with an input temporal state of the network to predict the state of the graph network at the one or more future time steps.

2. The computing system of claim 1, wherein the instructions are further executable to, during a training phase:
receive training data that includes time series data indicating a state of the graph network at each of a series of historical time steps; and
train the graph neural network using the training data to output the predicted state of the graph network at the one or more future time steps.

3. The computing system of claim 1, wherein the graph network comprises an energy distribution graph network, wherein the nodes represent a plurality of energy generation and/or energy consumption subsystems, and wherein the at least one edge represents an energy distribution linkage between the respective subsystems of each node.

4. The computing system of claim 3, wherein each state of the graph network includes:
for each node, an energy price and a rate of energy generation or energy consumption at that node; and
for each edge, an energy transmission rate and an energy transmission capacity.

5. The computing system of claim 4, wherein the energy transmission rate is constrained by the energy transmission capacity.

6. The computing system of claim 1, wherein each state of the graph network includes a plurality of node features and a plurality of edge features, which are variable between each state.

7. The computing system of claim 1, wherein each state of the graph network further comprises adjacency information.

8. The computing system of claim 1, wherein the temporal gate comprises a gated recurrent unit (GRU) or a long short-term memory (LSTM).

9. The computing system of claim 1, wherein the node spatial layer comprises a sigmoidal function σWₙ^{l}(xᵢ+AGG(xⱼ, eᵢⱼ)), xⱼ), where Wₙ^{l} is a nodewise weight at level l, AGG(xⱼ, eᵢⱼ) is an aggregate of a representation of a node xᵢ connected to a node xᵢ, and eᵢⱼ is a representation of an edge connecting the node xᵢ and the node xⱼ.

10. The computing system of claim 1, wherein the edge spatial layer comprises a sigmoidal function σ(Wₑ^{l}(eᵢⱼ+AGG(eₖₗ)), eₖₗ), where Wₑ^{l} is an edgewise weight at level l, eᵢⱼ is a representation of a first edge connecting a node (i) and a node (j), and AGG(eₖₗ) is an aggregate of a representation of a second edge connecting a node (k) and a node (l).

11. At a computing device, a method for predicting a future state of a graph neural network, the method comprising:
during a run-time phase,
receiving run-time input data that includes time series data indicating a state of a graph network at each of a series of time steps, the graph network including a plurality of nodes, and at least one edge connecting pairs of the nodes, and
inputting the run-time input data into a trained graph neural network to thereby cause the graph neural network to output a predicted state of the graph network at one or more future time steps, wherein the graph neural network includes,
a node spatial layer configured to receive, as input, the state of the graph network, and to output, for each node, an aggregate representation of a node neighborhood of the node,
an edge spatial layer configured to receive, as input for each edge of the at least one edge,
a representation of embedded edge features,
from the node spatial layer, an aggregate representation of a first node neighborhood of a first node connected by the edge, and
from the node spatial layer, an aggregate representation of a second node neighborhood of a second node connected by the edge, and
wherein the edge spatial layer is configured to output an aggregate representation of an edge neighborhood of the edge, and
a fully connected layer configured to receive output data from the node spatial layer and the edge spatial layer via a temporal gate, and to combine the output data from the node spatial layer and the edge spatial layer with an input temporal state of the network to predict the state of the graph network at the one or more future time steps.

12. The method of claim 11, further comprising:
receiving training data that includes time series data indicating a state of the graph network at each of a series of historical time steps; and
training the graph neural network using the training data to output the predicted state of the graph network at the one or more future time steps.

13. The method of claim 11, wherein the graph network comprises an energy distribution graph network, wherein the nodes represent a plurality of energy generation and/or energy consumption subsystems, and wherein the at least one edge represents an energy distribution linkage between the respective subsystems of each node.

14. The method of claim 13, wherein each state of the graph network includes:
for each node, an energy price and a rate of energy generation or energy consumption at that node; and
for each edge, an energy transmission rate and an energy transmission capacity.

15. The method of claim 11, wherein receiving the run-time input data further comprises receiving adjacency information for each state of the graph network.

16. The method of claim 11, wherein the temporal gate comprises a gated recurrent unit (GRU) or a long short-term memory (LSTM).

17. The method of claim 11, wherein the node spatial layer comprises a sigmoidal function σ(Wₙ^{l}(xᵢ+AGG(xⱼ, eᵢⱼ)), xⱼ), where Wₙ^{l} is a nodewise weight at level l, AGG(xⱼ, eᵢⱼ) is an aggregate of a representation of a node xⱼ connected to a node xᵢ, and eᵢⱼ is a representation of an edge connecting the node xᵢ and the node xⱼ.

18. The method of claim 11, wherein the edge spatial layer comprises a sigmoidal function σ(Wₑ^{l}(eᵢⱼ+AGG(eₖₗ)), eₖₗ), where Wₑ^{l} is an edgewise weight at level l, eᵢⱼ is a representation of a first edge connecting a node (i) and a node (j), and AGG(eₖₗ) is an aggregate of a representation of a second edge connecting a node (k) and a node (l).

19. A computing system, comprising:
a processor; and
a memory storing instructions executable by the processor to,
during a run-time phase,
receive run-time input data that includes time series data indicating a state of an energy distribution graph network at each of a series of time steps, the energy distribution graph network including nodes representing a plurality of energy generation and/or energy consumption subsystems, and at least one edge connecting pairs of the nodes, the edge representing an energy distribution linkage between the respective subsystems of each node, and
input the run-time input data into a trained graph neural network to thereby cause the graph neural network to output a predicted state of the energy distribution graph network at one or more future time steps, wherein the predicted state of the network at each future time step includes,
for each node, a predicted energy price at a future time, and
for each edge, a predicted energy transmission rate at the future time.

20. The computing system of claim 19, wherein the instructions are further executable to, during a training phase:
receive training data that includes time series data indicating a state of the energy distribution graph network at each of a series of historical time steps; and
train the graph neural network using the training data to output the predicted state of the energy distribution graph network at the one or more future time steps.
